(19) United States
(12) Patent Application Publication
(10) Pub. No.: US 2018/0258252 A1
(43) Pub. Date: Sep. 13, 2018

(54) DEVULCANIZED RUBBER, METHOD FOR ITS PREPARATION AND ITS USE AS AN ABSORBENT

(71) Applicant: YISSUM RESEARCH DEVELOPMENT CO OF THE HEBREW UNIVERSITY OF JERUSALEM LTD., Jerusalem (IL)

(72) Inventors: Yoel Sasson, Jerusalem (IL); Uri Stoin, Jerusalem (IL); Michael Kopylov, Beer-Sheva (IL); Vadim Goldshtein, Rehovot (IL)

(73) Assignee: YISSUM RESEARCH DEVELOPMENT CO OF THE HEBREW UNIVERSITY OF JERUSALEM LTD., Jerusalem (IL)

(21) Appl. No.: 15/913,256

(22) Filed: Mar. 6, 2018

(30) Foreign Application Priority Data
Sep. 8, 2016 (IL) PCT/IL2016/050997

(51) Int. Cl. C08J 11/16; B01J 20/26; B01J 20/28; B01J 20/30; B09C 1/08

(52) U.S. Cl. CPC C08J 11/16; B01J 20/265; B01J 20/28016; B01J 20/28057; B01J 2220/4893; B01J 20/2808; B01J 20/3007; B09C 1/08; C08J 2321/00; B01J 20/28069

(57) ABSTRACT

A process is provided for converting discarded rubber, e.g., rubber crumb, into absorbent material. The process comprises extruding a mixture of discarded rubber and oxidizer(s) under progressively increasing temperature to reach a temperature above 250° C. The extrudate may undergo a secondary oxidation. The partially devulcanized granular rubber formed is useful as absorbent material for hydrocarbons, e.g., in remediation of contaminated soil and oil spills.

The present invention relates to a process for converting discarded rubber into an absorbent useful in combating different types of land and water pollution and also for other purposes.

Land pollution occurs when chemicals accumulate in the soil matrix at a concentration higher than their natural occurrence. Frequently it is driven by human activities such as inadequate intensive agriculture, construction works, industrial and military activities, etc. It has been estimated that in the European Union over 3.5 million sites are potentially contaminated. The most common soil pollutants are: petroleum products, pesticides, halogenated solvents and pharmaceutical leftovers. Methods for remediation of oil-contaminated soils fall into two categories, ex-situ methods and in-situ methods. Ex-situ methods implicate excavation of polluted soils and their transport to a treatment site. In-situ methods allow on-site treatment of contamination without soil excavation.

Currently, the oceans are being polluted by many thousands of barrels of oil on a daily basis creating oil spills. Oil does not dissolve in water and it forms a thick sludge in water. These spills are catastrophic to local marine wildlife such as fish, birds and sea otters. Sweeping technology is considered the most effective process for oil spills treatment.

Infertility of soil in desert areas is one of the greatest global challenges of agriculture today including in Israel. Even with rains or artificial irrigation, the nature and porosity of soil matrix does not allow seepage of water into the desert ground with the result that water mainly flows over the surface.

Discarded tires and tire piles constitute a global problem. Annual global production of rubber tires is estimated at 270 million tones and it is rising exponentially. Currently, there is no sustainable solution for recycling of used tires rubbery. In Israel alone about 100,000 used tires are sent to landfills annually. Nonetheless, treatment of used tires is a regulatory liability in many countries. In the USA, about 50% of used tires are burned in cement kilns and paper mills. This solution is cheap but these industries are very polluting. Therefore, the only suitable solution to the problem of discarded tires resides in an effective recycling.

In most commercial applications, e.g., in tires manufacturing, rubbers are utilized in a vulcanized form, in which the polymer chains of raw (virgin) rubber are joined together by sulfur atoms. The process of cleaving (totally or partially) these sulfur bridges is known as de-vulcanization. The resultant de-vulcanized rubber can be utilized again in the same way like virgin rubber, that is, it can undergo crosslinking (re-vulcanization). The term ‘rubber’ as used herein is meant to include all types of rubber, i.e., natural and synthetic rubbers (for example, styrene-butadiene rubber (SBR), polybutadiene and ethylene-propylene (EPDM)).

There are a variety of methods for accomplishing rubber devulcanization based on mechanical, ultrasonic and chemical approaches. For example, EP 690091 describes a process for recycling tires with the aid of a chemical mixture which is added to a tire crumb subsequent to and during a roll-milling operation. In the method described in U.S. Pat. No. 7,189,762, different types of rubbers underwent extrusion with carbon dioxide being injected to the extruder.

As mentioned above, the chief goal of rubber devulcanization is to enable rubber reclaiming by re-vulcanization. However, it has been recognized that devulcanized rubber has its own set of benefits. It has been shown in U.S. Pat. No. 7,531,579 that the roll-milling of a mixture consisting of rubber crumb and (i) an organic acid, (ii) quinine group base and (iii) an anti-sliding agent, followed by extrusion of the mixture, results in the formation of porous granular material displaying good oil absorbance capacity. The experimental work reported in U.S. Pat. No. 7,531,579 indicates that the extruder operated with barrel zones being set at a temperature in the range from 120-200° C., preferably 120-150° C.

The present invention provides a simple and effective general approach to producing granules with desired properties from discarded rubber, for example used tires, combining thermo-mechanical and chemical rubber reclaiming processes, that is, making use of shear forces and chemical agents to accomplish rubber devulcanization. The method of the invention enables production from used tires of granules having a desired and controlled devulcanization level, which can be between 20 and 70%. The granules produced by the method of the invention have very high, and controlled porosity, and varied hydrophobicity/hydrophilicity character, making the particles useful both for absorption of hydrophobic materials such as oil or fuel spills as well as absorption of water, for example, for improving water retention and release properties of dry soil. The terms “pellets” and “granules” are used herein interchangeably.

The invention also provides a new economical and effective technology based on processed used tires for in-situ soil remediation and for efficient oil spills treatment with oil recovery. Furthermore this technology can also be used for improving the utilization of water resources (rains) in desert areas. All this is done by using granules produced from recycled rubbery tires as a raw material.

We have found that on subjecting a mixture of vulcanized waste rubber (e.g., rubber crumb from recycled tires) and one or more oxidizers to a progressively increasing temperature to reach a temperature above 250° C., and preferably above 300° C., under the application of pressure and shear forces, produces a partially devulcanized rubber in the form of porous pellets with greatly improved properties, in particular increased oil absorption.

Thus, the invention is primarily directed to a process for converting discarded rubber into absorbent material, comprising subjecting a mixture of discarded rubber and at least one oxidizer to a progressively increasing temperature to reach a temperature above 250° C. under pressure and shear forces, and collecting a partially devulcanized rubber in the form of granules.

The aforementioned conditions are achievable in an extruder in the presence of added chemical agents; either single-screw or twin-screw extruder may be employed. Thus, by one aspect the invention provides a process for partial devulcanization of used rubber, comprising contacting pellets of the used rubber with oxidizer material in an extruder under conditions of a temperature gradient, under pressure, for a pre-defined time period.

According to the invention, vulcanized waste rubber in a particulate form is processed in an extruder equipped with at least three temperature control zones along the barrel length (designated Hᵢ; 3≤i, for example, 39), wherein the barrel temperature profile is characterized in that the temperature difference between an upstream zone and a downstream zone is not less than 250° C., preferably not less than 270° C. More specifically, the temperature difference between rear upstream zone (T₁) and the final downstream zone (T_{f}) is not less than 250° C., preferably not less than 270° C. and most preferably not less than 300° C.

For example, the temperature gradient in the extruder may be from 20° C. to 420° C., preferably from 30 to 390° C. and more preferably from 40 to 360° C. along the barrel, with the endpoints of said temperature intervals being the temperatures set at the rear (T₁) and final downstream (T_{f}) zones, respectively. Temperatures of the intermediate zones gradually increase; preferably, the temperature difference between adjacent zones along the barrel (Tᵢ₊₁−Tᵢ) may be from 0-130° C., preferably from 30-120° C. The increments by which temperature is increased depend on the number of temperature control zones in the barrel. For example, a profile temperature suitable for a single-screw extruder equipped with four temperature control zones would be as follows:

30≤T₁≤100;100≤T₂≤200;200≤T₃≤300 and 300≤T₄≤420.

The residence time in the extruder is from 1 to 15 minutes, preferably 5 to 10 minutes. The pressure created in the extruder is from 50 to 200 atm, e.g., from 70 to 120 atm, for example, around 100 atm.

In addition to subjecting the rubber to temperature variation, high pressure and shear forces created in an extruder, rubber devulcanization is further advanced with the aid of at least one oxidizer, which is preferably premixed with the rubber particles before processing. The oxidizer is generally an inorganic salt selected from the group consisting of phosphate and nitrate salts, preferably a combination thereof. Phosphate salts include alkali and alkaline earth metal salts, such as trisodium phosphate, Na₃PO₄, tripotassium phosphate, K₃PO₄, and tricalcium phosphate, Ca₃(PO₄)₂. Other salts obtained from phosphoric acid, e.g., dihydrogen phosphate salts (NaH₂PO₄, KH₂PO₄) may also be used. The aforementioned phosphate salts are useful as devulcanization agents, that is, they act by cleaving S—S bonds. Nitrate salts include alkali metal nitrate salts, e.g., sodium nitrate, NaNO₃, and potassium nitrate, KNO₃. The total weight concentration of the oxidizer(s) based on the total weight of the feed material processed in the extruder is generally in the range from 0.5 to 5.0%, e.g., from 1.0 to 4.0%, for example, from 0.5 to 3% w/w (e.g., 1.0 to 2.5%), or from 3 to 5%.

A mixture consisting of at least one phosphate salt and at least one nitrate salt (for example, K₃PO₄+KNO₃) is preferably fed to the extruder to facilitate rubber devulcanization. The mixture of oxidizers is proportioned such that the nitrate is the predominant component, that is, the weight ratio M₃PO₄:MNO₃ preferably lies in the range 1:1 to 3:1 (M indicates an alkali metal which may be the same or different).

The process of the invention may comprise an additional step wherein the extrudate is subjected to a secondary oxidation, by contacting the extrudate with one or more auxiliary oxidizers in solution to obtain a modified extrudate, and processing the modified extrudate one more time in an extruder according to the conditions described for the first extrusion cycle. The auxiliary oxidizer(s) are dissolved in an aqueous solution in the cooling bath into which the extrudate is discharged. The auxiliary oxidizer(s) may be the same or different than the major oxidizers employed in the extrusion process, e.g., the auxiliary oxidizers may be selected from the group consisting of phosphate and nitrate salts, hydrogen peroxide and persulfate salts. The concentration of each of the aforementioned auxiliary oxidants in the solution may be from 1 to 30% by weight.

One embodiment of the invention relates to a process comprising feeding a waste rubber and one or more oxidizers to an extruder where the barrel temperature profile is set to create a temperature difference between an upstream zone and a downstream zone of not less than 250° C., preferably not less than 270° C., treating a pelletized extrudate with an aqueous solution of one or more auxiliary oxidizer(s), and extruding the pellets to recover porous granules useful as absorbents.

The porous granules made of devulcanized rubber (e.g., SBR) exhibit surface area of not less than 0.5 m²/gram, preferably not less than 1.0 m²/gram, more preferably not less than 1.2 m²/gram, e.g., above 1.5 m²/gram (e.g., from 1.5 m²/gram to 2.5 m²/gram, for example, up to 2.1 m²/gram, with pore volume of not less than 0.001 cm³/gram, e.g. between 0.001 and 0.01 cm³/gram, and average pore diameter between 10 and 50 Å, e.g., from 10 to 25 Å. The product can be defined as a poorly crosslinked elastomer with degree of devulcanization in the range from 20 to 70%, more specifically from 30 to 70%, e.g., from 30-50% or 50-70%. Methods for determining degree of devulcanization include elemental analysis, thermogravimetry and spectroscopic techniques such as FTIR.

### BRIEF DESCRIPTION OF THE DRAWINGS

FIG. 1 is a side, cross sectional view of an extrusion line in accordance with the principles of the present disclosure;

FIG. 2 is a chart including test results that show the increase in granules' weight;

FIG. 3 is a perspective view of test results showing the rates of grass growth;

FIG. 4 is a chart including test results discussed in Example 6;

FIG. 5 is a bar diagram showing results discussed in Example 6; and

FIG. 6 is a side, cross sectional view illustrating the utilization of the granules as soil additive.

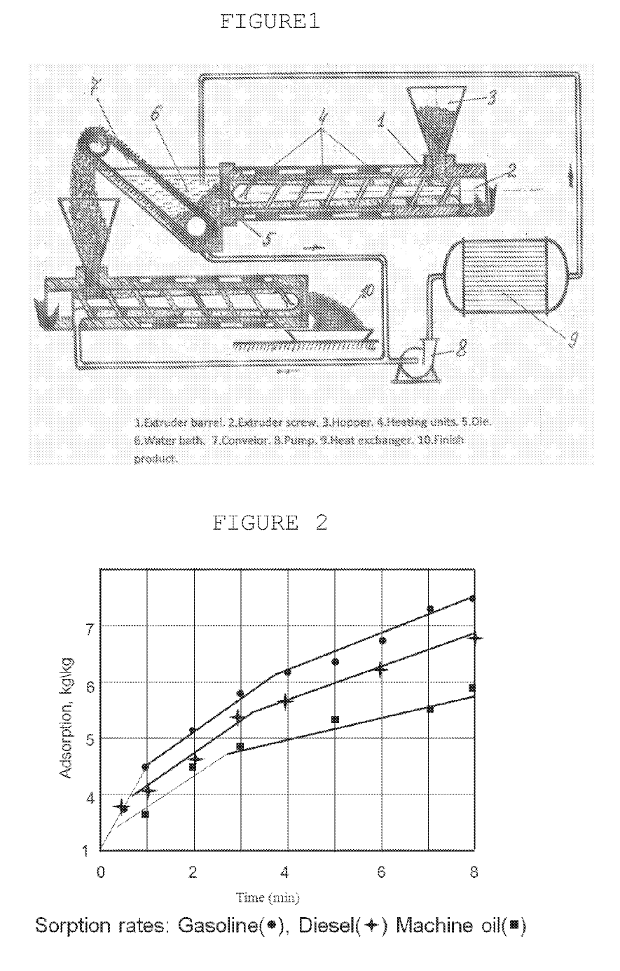

The process of the invention is now explained is reference to an extrusion line shown in FIG. 1. The extrusion design consists of two serially positioned single-screw extruders, to enable large scale production under continuous mode of operation. It should be understood that the configuration shown in FIG. 1 is essentially schematic and is provided for the purpose of illustration. Suitable single screw extruders operable in the rubber industry are readily available in the market, e. g., from ZHEJIANG BAINA Rubber&Plastic Equipment co. Ltd.

The chief parts of the extruder include the barrel (1) and a screw (2) which fits inside the barrel. The individual heating units positioned along the barrel are indicated by numeral (4). The extruder is further equipped with a motor drive system for rotating the screw and a control system for the barrel heating units and motor speed (not shown). Extruders suitable for use in processing the rubber in accordance with the invention have L/D ratio of 20 to 25.

The vulcanized waste rubber used as a feedstock material is fed to the extruder in the form of pellets or granules with particle size not exceeding 10 mm. A particularly suitable starting material consists of rubber (e.g., SBR) granules produced from recycled tires (recoverable by separating metals and fabric from tires, leaving tire rubber in a granular form which may be further processed to reduce its particle size). The recycled, granular rubber, e.g., ground rubber tire in different sizes is available on the market (e.g., crumb rubber).

The raw rubber in a granular/powder form is preferably premixed with the oxidizer(s) and the resultant blend is fed to the extruder via the hopper (3). Feeding rate is generally in the range from 30 to 130, preferably from 40 to 70 kg/hour. The added oxidizer is employed either in the form of pellets or powder. A portion of the oxidizer may be introduced to the extruder via downstream feeding means, which exists in some extruder configurations.

The temperatures in the individual heating zones are set to generate a temperature profile as described in detail above. The mixture consisting of the rubber and the oxidizer is extruded with screw speed in the range from 100 to 300 rpm, and the extrudate is discharged through the die (5) into a cooling water bath (6) filled with an aqueous solution with the auxiliary oxidizers dissolved therein, typically at a concentration in the range from 0.5-12% by weight. Pump (8) circulates water via heat exchanger (9), supplying water to the cooling bath and withdrawing water therefrom for cooling.

The extrudate is pelletized in the bath and the pellets settle on conveyor (7) which transports the modified pellets (after drying) into the hopper of a successively placed extruder operating under the same or similar conditions. The finished pellets/granules are cooled and collected (10) and transferred for the packing.

The hydrophobic granule of the invention is useful as absorbent: owing to its hydrophobicity and high surface area, the granule adsorbs many types of hydrophobic contaminants (e.g., hydrocarbons such as crude oil) readily and swiftly and retains them. The results reported below demonstrate that the granules of the invention display oil absorability exceeding 500% (e.g., the weight of oil absorbed is more than five times, and even more than seven times, the weight of the granular absorbent used). The absorbent does not release the absorbed hydrocarbons up to a temperature of 80° C. The absorbent further enables high oil recoverability; by pressing or squeezing the absorbent, more than 75% and even more than 85% of their content can be released and collected.

The porous granules resulting from the process can be put to use in absorbing hydrophobic contaminates from different mediums, for example:

(i) from particulate matter (e.g., for on-site application to remove hydrophobic contaminates from soil, sediment and sand soaked with hydrocarbons, to enable soil remediation without excavation);
(ii) from water, that is, spilled oil floating on water surface (remediation of light, nonaqueous-phase liquid (LNAPL) spills, created when oil is released into the ocean or coastal waters); and
(iii) oil stains spread over hard surfaces, such as roads and pavements, made of asphalt, concrete and cement.

Hydrophobic contaminates absorbable by the rubber absorbent of the invention include long chain alkanes and mixtures thereof (e.g., C₆₊, C₆-C₁₂, C₁₂-C₁₈, above C₁₈, C₂₀-C₃₀), such as gasoline, kerosene, diesel oil and also lubricating oils; aromatic hydrocarbons; polyaromatic hydrocarbons; and halogenated hydrocarbons, such as polychlorinated hydrocarbons.

One aspect of the invention is therefore a method for removing a hydrophobic contaminant from a particulate matter, comprising contacting the contaminated particulate matter with a sufficient amount of the rubber absorbent of the invention, separating the rubber absorbent from the particulate matter and optionally releasing the contaminant from the rubber to enable absorbent recycling and contaminant (e.g., hydrocarbon) recovery.

The weight ratio of the rubber absorbent to the contaminated particulate matter may be from 1:1 to 1:15, preferably from 1:3 to 1:8 parts by weight, depending on the level of contamination, type of contaminant to be eliminated, contemplated purification to be achieved and oil absorption capacity. The time of contact between the two solid phases (the contaminated particulate matter and the rubber absorbent) also depends on the aforementioned factors but in general a fairly rapid removal is attainable within hours. Contact can be facilitated mechanically, by mixing, shaking or tumbling the mixture consisting of the two solid phases. For example, for soil remediation, the contaminated soil is turned and loosened, following which the rubber absorbent is uniformly distributed and mixed into the soil to enable the extraction of the organic contaminant.

Different methods may be used to separate the rubber from the hydrocarbons-depleted particulate matter after the extraction step. For example, separation may be accomplished by sieving, that is, passing the mixture through suitable screens, enabling passage of the particulate matter while retaining the granular absorbent. Another separation technique is based on the difference in density between soil and rubber particles, that is, flooding the mixture with water in order to cause the rubber particles to float, following which the rubber particles are easily separable, e.g., by skimming the rubber particles off the water surface.

Another aspect of the invention is a method for combating an oil spill (LNAPL) floating on a water surface, comprising applying the rubber absorbent of the invention onto the oil spill, collecting the oil-containing absorbent and optionally releasing the oil from the rubber to enable absorbent recycling and oil recovery.

The rubbery absorbent of the invention has high affinity to hydrocarbons (oil) contaminants on account of its hydrophobic character. The granules are produced by extruding the starting material in the presence of added oxidizers, preferably at a concentration of not more than 3.0% w/w based on the total amount of rubber and additives (e.g., not more than 2.5% w/w, for example, 1.0-2.5% w/w). However, it is possible to introduce some hydrophilic character into the absorbent, rendering it useful for water absorption. That is, partial devulcanization of the rubber raw material allows hydrophobic-hydrophilic properties control of the absorbent granules. Enhanced devulcanization, e.g. above 50%, preferably above 60%, under enhanced oxidation generates granules with hydrophilic character. Such granules are obtained upon using increased amounts of oxidizers at the extrusion step, that is, for example, more than 3.0% w/w based on the total amount of rubber and additives. These granules can perform as artificial soil or soil additive as they have affinity to water. The invention allows production of rubbery granules with high ability of water adsorption, as shown in the experimental work reported below. The invention allows loading of water to these hydrophilic granules and utilization of natural rain and dew cycles in desert areas. Moreover, addition of these granules in desert areas can partially prevent inundation at winter period. The total weight of water may reach 1 kg per 1 kg of rubbery granules. These granules enable slow, controlled and comfortable release of water to the plants roots. In addition to this, the invention enables the production of partially hydrophilic and partially hydrophobic granules. This advanced technology allows ahead loading of water and fertilizers to granules surface. This kind of bi-functional soil additive would make barren soil to fertile.

Thus, the invention also provides a method of capturing and storing of rainwater and flood water, comprising adding to soil the granules which are obtained by the process of the invention under increased oxidation (e.g., with the aid more than 3.0% w/w oxidizer(s) at the extrusion step), for plant irrigation and other uses.

### EXAMPLES

### Methods

### Surface Area and Pore Volume Measurements

Surface area and pore volume were derived from N₂ adsorption-desorption isotherms using conventional BET and BJH methods. The samples were linear isotherms measured at liquid nitrogen temperature with NOVA instrument, Analysis Time: 103.2 min, Press. Tolerance:0.100/0.100 (ads/des), Outgas Temp: 80.0 C.

### Example 1

### Preparation of Partially Devulcanized Rubber Granules

Rubber pellets (5-10 mm), produced from discarded rubber tires, were used as a raw material (these pellets are available from Tyrec LTD, Israel).

The rubber pellets and an additive mixture consisting of potassium phosphate (0.5% w/w; in a powder form purchased from Sigma-Aldrich LTD.) and potassium nitrate (1% w/w; in a powder form purchased from Sigma-Aldrich LTD.) were premixed and fed to a single-screw extruder having 35 mm screw diameter operating in a 120 cm long barrel. The extruder barrel has four heating zones (H₁, H₂, H₃, H₄), and the barrel temperature was varied as follows: T₁=40° C., T₂=150° C., T₃=260° C. and T₄=360° C. The feed rate was 50 kg/hour. The pressure was about 100 atm and the reaction time was 5 min.

The extrudate was cut into pellets in a water bath filled with an aqueous solution comprising 10% w/w potassium phosphate and potassium nitrate (1:2 mixture) for cooling and enabling a secondary oxidation. The pellets underwent a further extrusion according to the conditions set forth above. The end product is a poorly cross-linked elastomer in the form of granules of 0.5-2.0 mm with particles surface area of 2.05 m²/g, pore volume of 0.003 cc/g and pore radius of 17.1 Å.

### Example 2

### Preparation of Partially Devulcanized Rubber Granules

Rubber pellets (5-10 mm), produced from discarded rubber tires, were used as a raw material (these pellets are available from Tyrec LTD, Israel).

The rubber pellets and an additive mixture consisting of potassium phosphate (0.5% w/w; in a powder form purchased from Sigma-Aldrich LTD.) and potassium nitrate (1% w/w; in a powder form purchased from Sigma-Aldrich LTD.) were premixed and fed to a single-screw extruder having 35 mm screw diameter operating in a 120 cm long barrel. The extruder barrel has four heating zones (H₁, H₂, H₃, H₄), and the barrel temperature was varied as follows: T₁=40° C., T₂=150° C., T₃=260° C. and T₄=360° C. The feed rate was 50 kg/hour. The pressure was 100 atm and the reaction time was 5 min.

The extrudate was cut into pellets in a water bath filled with an aqueous solution comprising 30% w/w hydrogen peroxide and 1% w/w sodium persulfate for cooling and enabling a secondary oxidation. The pellets underwent a further extrusion according to the conditions set forth above. The end product is a poorly cross-linked elastomer in the form of granules of 0.5-2.0 mm with particles surface area of 2.1 m²/g, pore volume of 0.004 cc/g and pore radius of 20 Å.

### Example 3

### Preparation of Partially Devulcanized Rubber Granules

Rubber pellets (5-10 mm), produced from discarded rubber tires, were used as a raw material (these pellets are available from Tyrec LTD, Israel).

The rubber pellets and an additive mixture consisting of potassium phosphate (1.5% w/w; in a powder form purchased from Sigma-Aldrich LTD.) and potassium nitrate (2% w/w; in a powder form purchased from Sigma-Aldrich LTD.) were premixed and fed to a single-screw extruder having 35 mm screw diameter operating in a 120 cm long barrel. The extruder barrel has four heating zones (H₁, H₂, H₃, H₄), and the barrel temperature was varied as follows: T₁=40° C., T₂=150° C., T₃=260° C. and T₄=360° C. The feed rate was 50 kg/hour. The pressure was 100 atm and the reaction time was 5 min.

The extrudate was cut into pellets in a water bath filled with an aqueous solution comprising 10% w/w potassium phosphate and potassium nitrate (1:2 mixture) for cooling and enabling a secondary oxidation. The pellets underwent a further extrusion according to the conditions set forth above. The end product is a poorly cross-linked elastomer in the form of granules of 0.5-2.0 mm with particles surface area of 2.0 m²/g, pore volume of 0.003 cc/g and pore radius of 17 Å.

### Example 4

### Measuring the Capacity of the Devulcanized Rubber Granules for Absorbing Hydrocarbons (Oils)

The granules of Example 1 were tested to measure their hydrocarbons absorption capacity. In a typical experiment, the hydrocarbon (8 kg) is placed in a container with 1 kg of the granules of Example 1. The mixture is held for a a period of time, during which period the absorption capacity is determined periodically by removing granules from the container and determining the increase in granules' weight.

The results are shown in FIG. 2, where the absorption capacity (kg/kg) is plotted versus time (minutes) for three different types of hydrocarbons: gasoline oil (marked with a circle); diesel oil (marked with a cross) and motor oil (marked with a square). It is seen that an absorption capacity exceeding 500% by weight has been achieved within less than seven minutes for all three types of oils tested.

### Example 5

### Partially Devulcanized Rubber Granules as Absorbents for Hydrocarbons for Use in Soil Remediation

The granules of Example 1 were tested to evaluate their ability to remove hydrocarbons from soil and enable rapid grass growth. Each of the following soil samples was placed in a separate aluminum tray (the dimensions of the trays used were 32×52×12 cm; the tray was filled with the soil up to a height of about 8 cm):

(1) uncontaminated soil;
(2) soil contaminated with 12% w/w motor oil; and
(3) soil contaminated with 12% w/w motor oil, comprising 2.2% w/w of the granules of the invention uniformly dispersed within the soil.

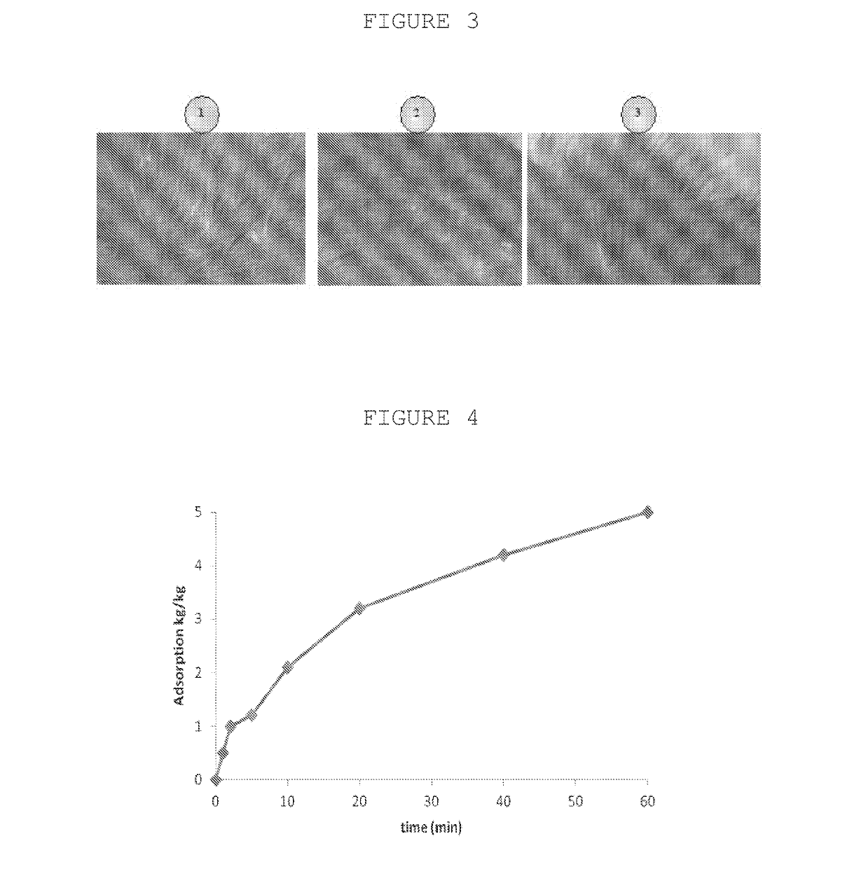

About 1 g of grass seeds (PICKSEED) were introduced 2 cm below the soil's surface. The soil samples were irrigated with 0.5 liter of water once in a two days. The results are shown in FIG. 3, which presents photos of the three samples, which were taken twenty one days after the beginning of the experiments. It is seen that the rates of grass growth in the control sample (1) and the treated sample (3) are comparable. In contrast, grass barely grew in the contaminated, untreated sample (2).

### Example 6

### Paretially Devulcanized Rubber Granules as Absorbents for Hydrocarbons for Use in LNAPL Remediation

The following experiment was carried out to assess the ability of the granules of Example 2 to recover LNAPL. Water (1000 g) was added to a chemical glass vessel, followed by the addition of 500 g of a crude oil. The granules of Example 2 (100 g) were then introduced into the vessel onto the oily layer distributed above the water surface. The granules were removed periodically from the vessel and their weight was recorded. The results are presented graphically in FIG. 4, where the gradually increasing weight of the granules was translated into absorption (kg/kg) versus time plot. It is seen that after sixty minutes, the weight of the oil absorbed was 500 g, (equivalent to five kg per 1 kg of the rubbery granules).

At the end of the experiment, the granules were collected and pressed with the aid of a garlic press to recover the oil. The results shown in the bar diagram presented in FIG. 5 correspond to an experiment where LNAPL consisting of 200 g crude oil was treated with 100 g of rubber granules. The results indicate that almost full recovery has been achieved, with the amount of oil squeezed out of the granules amounting to ˜90% of the total amount of oil absorbed (that is, 180 g).

### Example 7

### Partilaly Devulcanized Rubber Granules as Absorbents for Water for Use as Soil Additives

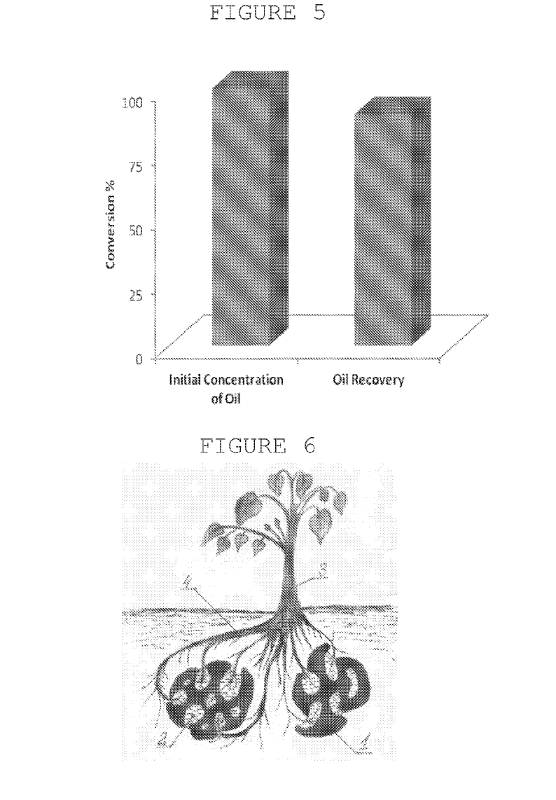

The granules of Example 3, possessing increased hydrophilic character compared with the granules of Examples 1 and 2, were tested to evaluate their ability to absorb water by adding the granules (100 g) to a flask containing water (100 ml). Full water absorption by the granules was obtained within minutes. FIG. 6 illustrates the utilization of the granules as soil additive. In view of their high porosity, the granules (1) distributed below the soil surface are able to serve as tiny reservoirs of water or water/fertilizer solutions (2) to enable slow, controlled and comfortable release of water to the roots (4) of the plant (3).

1. A process for converting discarded rubber into absorbent material, comprising subjecting a mixture of discarded rubber and at least one oxidizer to a progressively increasing temperature to reach a temperature above 250° C. under pressure and shear forces, and collecting a partially devulcanized rubber in the form of granules.

2. A process according to claim 1, wherein the discarded rubber used as a starting material is rubber crumb from recycled tires.

3. A process according to claim 1, wherein the discarded rubber is processed in an extruder equipped with at least three temperature control zones along the barrel length, under barrel temperature profile characterized in that the temperature difference between an upstream zone and a downstream zone is not less than 270° C.

4. A process according to claim 3, wherein the temperature difference between the rear upstream zone and the final downstream zone is not less than 300° C.

5. A process according to claim 1, wherein the oxidizer is an inorganic salt selected from the group consisting of phosphate salts, nitrate salts and a mixture thereof.

6. A process according to claim 5, comprising feeding to the extruder a mixture of at least one phosphate salt and at least one nitrate salt.

7. A process according to claim 6, wherein the nitrate is the predominant component in the mixture of oxidizers.

8. A process according to claim 3, further comprising a step of contacting the extrudate with one or more auxiliary oxidizers in solution to obtain a modified extrudate, and processing the modified extrudate one more time in an extruder.

9. A process according to claim 8, wherein the auxiliary oxidizer is selected from the group consisting of phosphate salts, nitrate salts, hydrogen peroxide and persulfate salts.

10. A process according to claim 8, comprising feeding a discarded rubber and one or more oxidizers to an extruder where the barrel temperature profile is set to create a temperature difference between an upstream zone and a downstream zone of not less than 250° C., discharging a pelletized extrudate into an aqueous solution of auxiliary oxidizers, drying the pellets and extruding the dried pellets to recover porous granules.

11. A process according to claim 3, wherein the concentration of the oxidizer(s) in the extrusion step is from 0.5 to 3% by weight based on the total weight of rubber and oxidizer(s).

12. A process according to claim 3, wherein the concentration of the oxidizer(s) in the extrusion step is above 3% by weight based on the total weight of rubber and oxidizer(s).

13. Partially devulcanized rubber absorbent in the form of porous granules obtainable by the process of claim 1.

14. Partially devulcanized rubber absorbent in the form of porous granules having surface area of not less than 1 m²/gram, with pore volume of not less than 0.001 cm³/gram, and average pore diameter between 10 and 25 Å.

15. A method of removing a hydrophobic contaminant from a particulate matter, comprising contacting the contaminated particulate matter with a sufficient amount of the absorbent of claim 13, separating the rubber absorbent from the particulate matter and optionally releasing the contaminant from the rubber to enable absorbent recycling and hydrocarbon recovery.

16. A method of combating an oil spill floating on a water surface, comprising applying the rubber absorbent of claim 13 onto the oil spill, collecting the oil-containing absorbent and optionally releasing the oil from the rubber to enable absorbent recycling and oil recovery.

17. A method of capturing and storing of rainwater or flood water, comprising adding to soil granules obtainable by the process of claim 12.

18. A method according to claim 17, employed for plant irrigation.

19. A method of removing a hydrophobic contaminant from a particulate matter, comprising contacting the contaminated particulate matter with a sufficient amount of the absorbent of claim 14, separating the rubber absorbent from the particulate matter and optionally releasing the contaminant from the rubber to enable absorbent recycling and hydrocarbon recovery.

20. A method of combating an oil spill floating on a water surface, comprising applying the rubber absorbent of claim 14 onto the oil spill, collecting the oil-containing absorbent and optionally releasing the oil from the rubber to enable absorbent recycling and oil recovery.
